(19) United States
(12) Patent Application Publication
(10) Pub. No.: US 2005/0176443 A1
(43) Pub. Date: Aug. 11, 2005

(54) Cellular phone geolocation system

(76) Inventor: J. Doss Halsey, Falls Church, VA (US)

Correspondence Address: NEIL K. NYDEGGER;NYDEGGER & ASSOCIATES, 348 Olive Street, San Diego, CA, 92103, US

(21) Appl. No.: 10/774,911

(22) Filed: Feb. 9, 2004

(51) Int. Cl. H04Q 7/20

(52) U.S. Cl. 455/456.5

(57) ABSTRACT

A geolocation system for locating a cellular phone in a service area includes an auxiliary receive channel incorporated into the cellular phone. A plurality of transmitters are mutually dispersed at known locations to transmit low frequency beacon signals into the service area. Each beacon signal includes an identifying characteristic that can be used to identify the particular transmitter the signal emanated from. The low frequency of the signal prevents urban features within the service area from acting as signal waveguides and altering the path of the signal. When the user dials a predetermined number such as “911”, the auxiliary receive channel is activated to receive the transmission signals and extract phase related information and the identifying characteristic from each signal. The extracted information is then transmitted to a base station using the cellular phone's normal communication link where the information is processed to determine the location of the cellular phone.

### FIELD OF THE INVENTION

The present invention pertains generally to cellular phone geolocation systems. More particularly, the present invention pertains to systems and methods for locating a cellular phone user within a cellular phone service area. The present invention is particularly, but not exclusively, useful as a system for locating a cellular phone user that has made an emergency 911 call.

### BACKGROUND OF THE INVENTION

In many situations and for many reasons it may be desirable to locate the user of a cellular phone. Of particular interest is the desire to locate an emergency 911 caller within an urban area who may or may not be inside a building. Recently, the frequency of occurrences wherein it would be desirable to rapidly locate a cellular phone has increased dramatically. This is due in part because the number of cellular phone users is rapidly growing as wireless communication companies are continually finding ways to reach new consumers with the latest technology. Compounding this statistic is the fact that the proportion of emergency 911 calls originating from cellular phone users as opposed to landline users is growing since by the very nature of mobile phones, they are most likely to be the nearest and most rapid means to communicate in an emergency situation.

Mobile cellular phones inherently present a more complex task of locating the user than traditional hard-wired phones. This complexity is due to the fact that cellular phones continually change their physical location and are often powered off during some or all of this movement to preserve the charge on the phone's battery. In addition, the user of a cellular phone is less likely to know their location in terms of, for example, an exact address.

To accurately locate and track objects or individuals inside or adjacent to the types of structures that are typically present in urban areas, the tracking signal that is used by the system must have good penetration through the walls and other features of the structures and with little signal path distortion. Lack of adequate signal penetration can result in a loss of signal strength which in turn can cause unacceptable location errors. Also, the signal should have low deflection (refraction and diffraction) to reduce the presence of multipath signals which limit location accuracy. Furthermore, to locate an object's position accurately indoors, a system must provide sufficient coverage, and be able to acquire the signals quickly.

Unfortunately, radiofrequency (RF) systems using high frequency signals are limited in their ability to penetrate the walls and features of a structure. Also, because high frequency signals have wavelengths that are much shorter than the size of typical structural features such as rooms, hallways and staircases, these features can act as waveguides for the high frequency waves, altering the path of the signal. On the other hand, low frequency RF signals offer the potential to penetrate the walls and features of a structure and overcome inaccuracies due to fading and path length perturbations caused by diffraction and reflection. Further, since the wavelength of the low frequency waves are approximately the same or greater than the size of typical structural features, the features do not act as waveguides for the low frequency waves. Consequently, low frequency RF signals having wavelengths greater than the size of structural features are preferred over high frequency signals for use in and around structures.

Favorable geometry can also be used to reduce the effects of multipath in urban areas. As the signal wavelength is increased to sizes greater than building sizes in an urban area, adjacent buildings and structures become the predominant scattering sources. Reducing the distance between the transmitters and the receiver (e.g. by using microcells) will enhance the multipath immunity in these situations. For relatively small distances between transmitter and receiver, the path length difference between the direct path and the reflected path (e.g. from other buildings) will be a greater fraction of the direct path tending to cause multipath signals to vary by significant fractions in amplitude (typically 3 dB or more) from the direct path. This significant amplitude difference between direct and multipath signals will result in lower null depth and lower phase error due to the multipath signal. On the other hand, for relatively large distances between transmitter and receiver, the signal will scatter from adjacent buildings with the path-length-difference being only a small fraction of the direct path length. Thus, the two signals will interfere causing deep nulls and significant phase error. This phenomenon is the main reason that existing long-range low-frequency phase-only systems, such as Loran, do not work well in urban areas.

Traditional positioning technologies typically use time-of-arrival and the angle-of-arrival methods. In a typical time-of-arrival system, the system measures the time of arrival of a marker modulated onto a signal to determine range. However, in time-of-arrival systems, increased resolution can only be obtained at the expense of increased bandwidth. By way of example, for a desired locating accuracy of one meter, a typical ranging system based on time of arrival requires a bandwidth on the order of tens of MHz. Unfortunately, this much bandwidth (tens of MHz) is unavailable at the low frequencies required to accurately locate objects within structures.

In light of the above, it is an object of the present invention to provide systems and methods for locating a cellular phone user within a cellular phone service area. It is yet another object of the present invention to provide a system for geolocating a cellular phone that is accurate to within a few meters in an urban setting, with the phone positioned indoors or outdoors. Another object of the present invention is to provide a cellular phone geolocation system that does not required the cellular phone to be powered on at all times and does not place a significant burden on the cellular phone's internal battery. It is still another object of the preset invention to provide a cellular phone geolocation system that is automatically activated when a particular cellular phone dials 911 in order to locate the user in an emergency situation.

### SUMMARY OF THE INVENTION

A system for geolocating a cellular phone that is positioned at an unknown location within a cellular phone service area includes an auxiliary receive channel incorporated into the cellular phone, a plurality of transmitters and a base station. For the present invention, the transmitters are mutually dispersed at known locations and are arranged to ensure signal coverage by at least three transmitters at each point in the cellular phone service area. In one implementation, the transmitters are placed on existing cellular towers or co-located with existing cellular assets.

For the geolocating system, each transmitter is configured to transmit a respective beacon signal at a known frequency, and each respective beacon signal includes an identifying characteristic that can be used to identify the particular transmitter. Several techniques can be used to distinguish transmitted beacon signals including assigning a unique transmitting frequency to each transmitter, or modulating an identifier code on each beacon signal.

In greater detail, the beacon signals generated by the transmitters are low frequency signals to ensure that each beacon signal will penetrate into buildings within the cellular phone service area. Additionally, the low frequency of the beacon signal prevents urban features within the service area from acting as waveguides for the beacon signal and altering the path of the beacon signal. These urban features that can act as waveguides include rooms, hallways, staircases and passageways between large buildings. For the present invention, the beacon signals generated by the transmitters have a wavelength that is substantially longer than the pertinent dimensions of the urban features to prevent these features from acting as waveguides. A typical frequency for use in the present invention is between approximately 500 kHz and approximately 2 Mhz. As detailed further below, in one implementation, AM signals from existing AM radio station transmissions can be used as beacon signals.

As indicated above, the cellular phone includes an auxiliary receive channel. When activated, the auxiliary receive channel is configured to receive and process the beacon signals. In one embodiment of the present invention, the auxiliary receive channel is activated when the cellular phone user dials a predetermined number such as “911”. For each received beacon signal, phase related information and the identifying characteristic are extracted from the beacon signal. The extracted information is then transmitted to the base station by the cellular phone using the cellular phone's standard communication link. At the base station, the information received from the cellular phone can be used to determine the location of the cellular phone.

In a first embodiment of the present invention, the transmitters are synchronized with each other to allow the generated beacon signals to have a known, initial phase relationship with each other as they are generated by the transmitters. At the cellular phone, however, the beacon signals will not necessarily arrive having the initial phase relationship. This is because each beacon signal will have most likely traveled a different distance in reaching the cellular phone. In one implementation, the transmitters are synchronized using a common time reference at each transmitter. For example, a Global Positioning System (GPS) can be used to provide a suitable common time reference or a plurality of synchronized atomic clocks may be used.

At the base station, the phase relationship for beacon signals received at the cellular phone can be compared to the initial phase relationship to establish a relative phase delay for each transmitter pair. For example, three pair-wise relative phase delays can be calculated for a system having three transmitters. Each relative phase delay is indicative of a differential range estimate for the respective transmitter pair. Specifically, the differential range estimate indicates the difference between the distance from the cellular phone to one transmitter in the pair and the distance from the cellular phone to the other transmitter in the pair. Since it is unknown which 2π cycle of the sinusoid each received beacon signal is on, each relative phase delay can represent several possible differential range estimates. As detailed further below, these phase related ambiguities can be resolved and the location of the cellular phone can be calculated from the differential range estimates using triangulation algorithms.

In another embodiment of the present invention, transmitter synchronization using a common time reference is not required. Instead, a system receiver is placed at a known location to receive and process the beacon signals. By reversing the process described above, the phase relationship for beacon signals received at the cellular phone can be used to determine the initial phase relationship for the beacon signals (i.e. the phase relationship between beacon signals as they are generated by the transmitters). Once the initial phase relationship for the beacon signals is known, the system can then geolocate a cellular phone that is positioned at an unknown location, in the same manner as described above for synchronized transmitters.

In each of the embodiments described above, the phase related ambiguities can be eliminated by a processor at the base station to find the real cellular phone position. It is to be appreciated that the number of ambiguities will depend on the wavelength(s) of the beacon signals, the size of the coverage area and the number and distribution of transmitters. Several techniques can be used to reduce or eliminate the ambiguities. A preferred technique involves using a high-resolution algorithm such as the Maximum Likelihood Method (MLM) to eliminate the phase related ambiguities and find the real receiver position.

Another technique for eliminating ambiguities involves using transmitters configured to transmit at multiple frequencies. Here, a set of possible receiver positions is produced for each frequency. The set of possible receiver positions produced at one frequency can then be compared to the set of possible receiver positions produced at a second frequency and any possible receiver positions that are not common to both sets can be eliminated as ambiguities. Once the ambiguities have been eliminated, the remaining position is the real position of the receiver relative to the transmitters. It is to be appreciated that a combination of the above-described techniques can be used to reduce or eliminate phase related ambiguities.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective illustration of the cellular phone geolocation system shown in operation in an urban environment; and

FIG. 2 is an illustration of a cellular phone for use in the cellular phone geolocation system.

### DESCRIPTION OF THE PREFERRED EMBODIMENTS

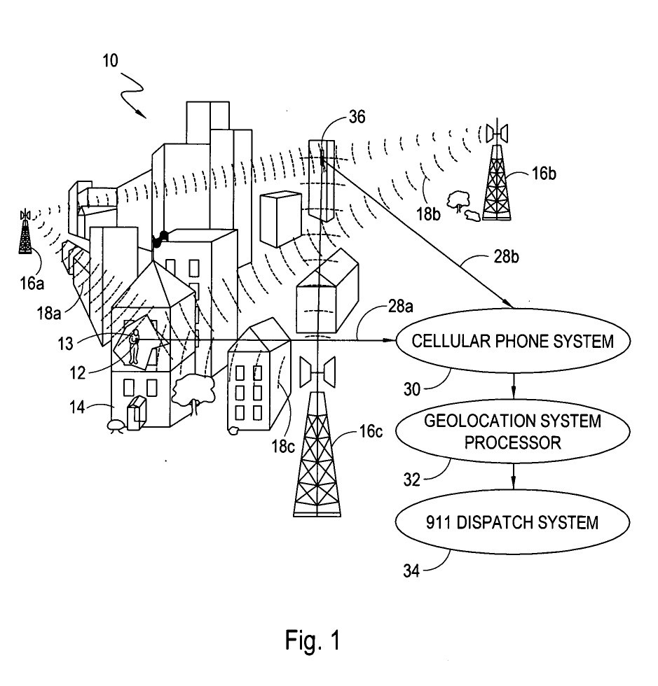

Referring initially to FIG. 1, an arrangement of a cellular phone geolocation system is shown and is generally designated 10. The basic object of the system 10 is to determine the location of a cellular phone 12, and if desired the user 13, within a cellular phone service area that can be an urban environment, as shown. Further, this is to be accomplished during periods when the cellular phone 12 is stationary or mobile, outdoors or inside a building such as exemplary building 14.

In overview, FIG. 1 shows that system 10 includes a plurality of transmitters 16a-c that can be installed on cell towers, as shown. In general, the transmitters 16a,b shown in FIG. 1 can be arbitrarily located as long as the transmitters 16a-c are mutually dispersed and their actual location is known. If possible, it is preferable to position the transmitters 16a-c relative to each other to obtain favorable geometric dilution of precision (GDOP). Although three transmitters 16a-c are shown in FIG. 1, it is to be appreciated that additional transmitters 16 in excess of three can be added as desired.

For the system 10, each transmitter 16a-c is configured to transmit a respective beacon signal 18a-c at a known frequency, and each respective beacon signal 18a-c includes an identifying characteristic that can be used to identify the particular transmitter 16a-c. Several techniques can be used to distinguish transmitted beacon signals 18a-c including separating the beacon signals 18a-c in time, frequency, or code space.

In greater detail, the beacon signals 18a-c generated by the transmitters 16a-c are low frequency electromagnetic signals to ensure that each beacon signal 18a-c will penetrate into buildings within the cellular phone service area. Additionally, the low frequency of each beacon signal 18a-c prevents urban features within the service area from acting as waveguides for the beacon signals 18a-c and altering the path of the beacon signals 18a-c. These urban features that can act as waveguides include rooms, hallways, staircases and passageways between large buildings. For the system 10, the beacon signals 18a-c generated by the transmitters 16a-c can have a wavelength that is substantially longer than the pertinent dimensions of the urban features to prevent these features from acting as waveguides.

Additional considerations may affect the choice of frequency for the beacon signals 18a-c. As indicated above, the highest operating frequency is generally limited to ensure building penetration and to prevent urban features from acting as waveguides. The lowest operating frequency, on the other hand, may be limited by the ability to accurately estimate the phase of the beacon signals 18a-c in noise (mathematically represented by the Cramer Rao lower bound). Also, Federal Communication Commission (FCC) regulations may limit the frequencies used in a system 10 as described herein. A typical frequency for use in the present invention is between approximately 500 kHz and approximately 2 Mhz. In some implementations of the system 10, the power and bandwidth of the beacon signals 18a-c can be increased to provide processing gain to the cellular phone 12 to provide some immunity to the effects of external noise sources.

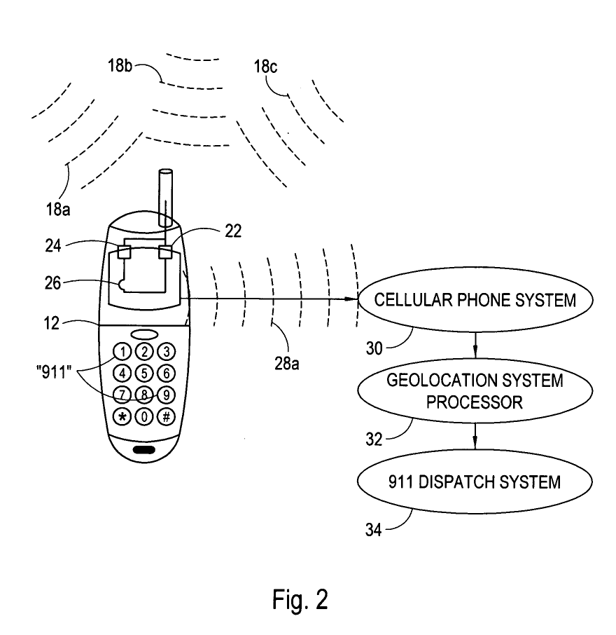

Referring now to FIG. 2, a cellular phone 12 is shown. As shown, the cellular phone 12 includes a standard channel 22 for sending and receiving voice, data and/or other communications to and from a cell tower antenna that is part of a standard cellular phone system. Further, as shown, a dedicated auxiliary receive channel 24 is incorporated in the cellular phone 12 for use in the system 10. When activated, the auxiliary receive channel 24 is configured to receive and process the beacon signals 18a-c. In one embodiment of the system 10, a switch 26 is provided to activate the auxiliary receive channel 24 when the cellular phone user 13 dials a predetermined number such as “911”. For each received beacon signal 18a-c, phase related information and the identifying characteristic are extracted from the beacon signals 18a-c.

Cross referencing FIGS. 1 and 2, it can be seen that the extracted information can be transmitted via communications link 28a using the standard channel 22 to the cellular phone system 30. From the cellular phone system 30, the extracted information is forwarded to a geolocation system processor 32 which is located at a base station. At the base station, the extracted information received from the cellular phone 12 can be used by the processor 32 to determine the location of the cellular phone 12. As further shown, the location of the cellular phone 12 can be forwarded, along with the call from the user 13 to the 911 dispatch system 34.

In a first implementation of the system 10, the transmitters 16a-c are synchronized with each other to allow the generated beacon signals 18a-c to have a known, initial phase relationship with each other as they are generated by the transmitters 16a-c. At the cellular phone 12, however, the beacon signals 18a-c will not necessarily arrive having the initial phase relationship. This is because each beacon signal 18a-c will have most likely traveled a different distance in reaching the cellular phone 12. In one embodiment of the system 10, the transmitters 16a-c are synchronized using a common time reference at each transmitter 16a-c. In a particular embodiment, GPS can be used to provide a suitable common time reference to synchronize the transmitters 16a-c. Using typical GPS time-transfer techniques which are accurate to approximately 12 ns, the GPS time reference would be adequate to allow the system 10 to locate a cellular phone 12 well within the 50 meter requirement that is currently contemplated for emergency 911 systems. In another particular embodiment of the system 10, a plurality of synchronized atomic clocks are used to provide a common time reference to each transmitter 16a-c.

At the base station, the phase relationship for beacon signals 18a-c received at the cellular phone 12 can be compared to the initial phase relationship to establish a relative phase delay for each pair of transmitters 16a-c. For example, three pair-wise relative phase delays can be calculated for a system having three transmitters 16a-c. Each relative phase delay is indicative of a differential range estimate for the respective pair of transmitters 16a-c. Specifically, the differential range estimate indicates the difference between the distance from the cellular phone 12 to one transmitter 16a-c in the pair and the distance from the cellular phone 12 to the other transmitter 16a-c in the pair. Since it is unknown which 2π cycle of the sinusoid each received beacon signal 18a-c is on, each relative phase delay can represent several possible differential range estimates. As detailed further below, these phase related ambiguities can be resolved and the location of the cellular phone 12 can be calculated by the processor 32 from the differential range estimates using triangulation algorithms.

After synchronization as described above, one or more system receivers such as system receiver 36 can be placed at one or more known locations in the cellular phone service area to calibrate and verify the accuracy of the system 10. As shown, system receiver 36 can communicate extracted information from the beacon signals 18a-c to the cellular phone system 30 via link 28b, which in turn can forward the extracted information to the geolocation system processor 32 at the base site.

In another embodiment of the system 10, synchronization of the transmitter 16a-c using a common time reference is not required. Instead, one or more system receivers, such as system receiver 36 shown in FIG. 1, is placed at a known location to receive and process the beacon signals 18a-c. By reversing the process described above, the phase relationship for beacon signals 18a-c received at the cellular phone 12 can be used to determine the initial phase relationship for the beacon signals 18a-c (i.e. the phase relationship between beacon signals 18a-c as they are generated by the transmitters 16a-c). Once the initial phase relationship for the beacon signals 18a-c is known, the system 10 can then geolocate a cellular phone 12 that is positioned at an unknown location, in the same manner as described above for synchronized transmitters 16a-c.

In each of the embodiments of the system 10 described above, the phase related ambiguities can be eliminated by the processor 32 at the base station to find the real position of the cellular phone 12. It is to be appreciated that the number of ambiguities will depend on the wavelength(s) of the beacon signals 18a-c, the size of the cellular phone service area covered by the system 10 and the number and distribution of transmitters 16a-c. Several techniques can be used to reduce or eliminate the ambiguities. A preferred technique involves using an algorithm such as the Maximum Likelihood Method (MLM) to eliminate the phase related ambiguities and find the real position of the cellular phone 12. For more information on the MLM method, see J. Capon, “High Resolution Frequency-Wavenumber Spectrum Analysis,” Proc. IEEE, Vol. 57, No. 8, August 1969.

Another technique for eliminating ambiguities involves using transmitters 16a-c configured to transmit at multiple frequencies. With this technique, a set of possible positions of the cellular phone 12 is produced for each frequency. The set of possible positions for the cellular phone 12 produced at one frequency can then be compared to the set of possible positions for the cellular phone 12 produced at a second frequency and any possible positions for the cellular phone 12 that are not common to both sets can be eliminated as ambiguities. Once the ambiguities have been eliminated, the remaining position is the real position of the cellular phone 12 relative to the transmitters 16a-c. It is to be appreciated that a combination of the above-described techniques can be used to reduce or eliminate phase related ambiguities.

Another method for mitigation of ambiguities is to use a coarse/fine vernier approach. There are various ways to locate the cellular phone 12 in a coarse fashion. In one particular embodiment, cellular phone system information is used to determine which cell the cellular phone 12 is located in. Positions located outside the cell can be eliminated as ambiguities. In some applications, beacon signals 18a-c having sufficiently long wavelengths such that there are no ambiguities within the footprint of a cell can be used. In another embodiment of the system 10, timing information of the cellular phone waveform, for example IS95 (Qualcomm Spread Spectrum) or TDMA (time division multiple access) information is used to provide coarse geolocation information that can be used to reduce or eliminate ambiguities.

In another embodiment of the system 10, one or more of the transmitters 16a-c can be AM radio station transmitters. Typical analog AM radio station signals have high carrier signal power and a have a relatively low carrier frequency allowing the AM signal to penetrate buildings and preventing urban features from acting as waveguides. In one implementation, a scanning circuit is incorporated in the cellular phone 12 to scan the AM band. The carrier phase of the one or more AM frequencies are measured with respect to an internal oscillator as a reference. These phase angles are transmitted across the cellular phone's standard communications link 28a to the processor 32 where the position of the cellular phone 12 is computed. Alternatively, the phase of the AM signal can be measured relative to one of the other transmitters 16a-c. As described above, a system receiver 36 that is positioned at a known location can be used to receive and process the beacon signals 18a-c including AM signals. As described above, the phase relationship for beacon signals 18a-c including AM signals received at the system receiver 36 can be used to determine the initial phase relationship for the beacon signals 18a-c including AM signals (i.e. the phase relationship between beacon signals 18a-c including AM signals as they are generated by the transmitters 16a-c).

While the particular Cellular Phone Geolocation System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. A system for geolocating a cellular phone, said system comprising:
a base station having a processor;
a plurality of dispersed transmitters for transmitting respective beacon signals from respective known locations, wherein each said beacon signal has an identifying characteristic for said respective transmitter;
a receive channel incorporated into said cellular phone, with said receive channel being activated to receive phase information from said beacon signals whenever said cellular phone dials a predetermined number; and
a means for passing said identifying characteristic and said phase information for each said beacon signal to said base station for use by said processor in determining the geolocation of said cellular phone.

2. A system as recited in claim 1 wherein said predetermined number is 911.

3. A system as recited in claim 1 wherein said identifying characteristic is a frequency of said beacon signal.

4. A system as recited in claim 1 wherein said identifying characteristic is a code on said beacon signal.

5. A system as recited in claim 1 wherein at least one said transmitter is an AM radio station.

6. A system as recited in claim 1 further comprising calibration means to verify the accuracy of said system.

7. A system as recited in claim 1 further comprising a means for synchronizing each transmitter.

8. A system as recited in claim 7 wherein said synchronizing means comprises a common time reference supplied to each transmitter from a Global Positioning System (GPS).

9. A system as recited in claim 7 wherein said synchronizing means comprises a plurality of atomic clocks to provide a common time reference to each transmitter.

10. A system as recited in claim 1 wherein each said beacon signal has a wavelength longer than 150 meters to allow each said beacon signal to penetrate structures.

11. A system as recited in claim 1 wherein at least one said transmitter is configured to transmit a plurality of beacon signals of differing frequency.

12. A system for geolocating a cellular phone in an urban area, said system comprising:
a plurality of dispersed transmitters for transmitting respective beacon signals into the urban area from respective known locations, wherein each said beacon signal has an identifying characteristic for said respective transmitter and each said beacon signal has a wavelength longer than 150 meters to allow each said beacon signal to penetrate structures in the urban area;
a means coupled with the cellular phone for receiving said beacon signals and extracting phase information and said identifying characteristics from each said beacon signal; and
a means for using said phase information and said identifying characteristics to geolocate the cellular phone.

13. A system as recited in claim 12 wherein said means for using said phase information in said beacon signals to calculate the location of the target comprises a processor configured to process a Maximum Likelihood Method (MLM) algorithm to eliminate phase-related location ambiguities.

14. A system as recited in claim 12 wherein said means coupled with the cellular phone for receiving said beacon signals and extracting phase information and said identifying characteristics from each said beacon signal comprises a receive channel incorporated into said cellular phone, with said receive channel being activated to receive said beacon signals whenever said cellular phone dials a predetermined number.

15. A system as recited in claim 12 further comprising a means for synchronizing each transmitter.

16. A system as recited in claim 15 wherein said synchronizing means comprises a common time reference supplied to each transmitter from a Global Positioning System (GPS).

17. A method for geolocating a cellular phone within a service area, said method comprising the steps of:
transmitting beacon signals into the service area from a plurality of dispersed predetermined locations, each beacon signal having a different identifying characteristic;
receiving said beacon signals at the cellular phone;
extracting phase information and said identifying characteristic from said beacon signals; and
using said phase information and said identifying characteristic to determine the position of said cellular phone.

18. The method as recited in claim 17 wherein said receiving step comprises the step of activating a receive channel whenever said cellular phone dials a predetermined number.

19. The method as recited in claim 17 wherein said step of using said phase information and said identifying characteristic to determine the position of said cellular phone comprises the step of calculating a pair-wise phase difference for at least two pairs of said beacon signals received at the cellular phone.

20. The method as recited in claim 17 wherein each said beacon signal has a wavelength longer than 150 meters to allow each said beacon signal to penetrate structures.
